(19) United States
(12) Patent Application Publication
(10) Pub. No.: US 2025/0106769 A1
(43) Pub. Date: Mar. 27, 2025

(54) METHOD AND APPARATUS FOR MONITORING DOWNLINK CONTROL INFORMATION, AND READABLE STORAGE MEDIUM

(71) Applicant: Beijing Xiaomi Moblie Software Co., Ltd., Beijing (CN)

(72) Inventor: Ting FU, Beijing (CN)

(21) Appl. No.: 18/729,698

(22) PCT Filed: Jan. 25, 2022
(86) PCT No.: PCT/CN2022/073872

§ 371 Date: Jul. 17, 2024

(51) Int. Cl. H04W 52/02; H04W 72/231; H04W 72/51

(52) U.S. Cl. CPC H04W 52/0235; H04W 72/231; H04W 72/51

(57) ABSTRACT

A method for monitoring downlink control information (DCI) is performed by a user equipment. The method includes: in response to that the user equipment is in a sleep duration and does not receive a wake-up signal (WUS) that is used for indicating wake-up, not monitoring at least one of a DCI scrambled with Paging Radio Network Temporary Identifier (P-RNTI) or a DCI scrambled with System Information RNTI (SI-RNTI).

### CROSS-REFERENCE TO RELATED APPLICATIONS

The present application is a U.S. National Stage of International Application No. PCT/CN2022/073872, filed on Jan. 25, 2022, the disclosure of which is incorporated herein by reference in its entirety.

### TECHNICAL FIELD

The present disclosure relates to the field of wireless communication technology, and in particular to a method and apparatus for monitoring downlink control information and a readable storage medium.

### BACKGROUND

In wireless communication technology, such as 5th Generation Mobile Communication Technology (5G), in order to save power consumption of User Equipment (UE), a main transceiver may enter into a sleep mode.

A network device can send a wake-up signal (WUS), which can indicate to one or more UEs whether to wake up for downlink monitoring. For example, the WUS includes 16 bits that correspond to 16 UEs, and each bit corresponds to one UE. When the bit corresponding to a UE is 1, it indicates wake-up, and the UE turns on the main transceiver to receive downlink signals: and when the bit corresponding to the UE is 0, it indicates not to wake up, and the UE maintains the main transceiver in the sleep mode.

In some implementations, when the user equipment is in a sleep mode under a Radio Resource Control (RRC) connected state, it monitors some Downlink Control Information (DCIs) and does not monitor some other DCIs.

### SUMMARY

The present disclosure provides a method and an apparatus for monitoring downlink control information and a readable storage medium.

In a first aspect, there is provided a method for monitoring downlink control information, the method being performed by a user equipment and including:

in response to that the user equipment is in a sleep duration and does not receive a wake-up signal (WUS) that is used for indicating wake-up, not monitoring at least one of a DCI scrambled with P-RNTI or a DCI scrambled with SI-RNTI.

In a second aspect, there is provided a method for monitoring downlink control information, the method being performed by a network device and including:

in response to that there is downlink information to be received by user equipment, or that there is update of a system message or warning information is generated, sending a wake-up signal (WUS) that is used for indicating wake-up to the user equipment.

In a third aspect, there is provided a communication apparatus. The communication apparatus may be provided in a user equipment and include a processor, a memory, and a transceiver.

The transceiver is configured to not monitor at least one of a DCI scrambled with P-RNTI and a DCI scrambled with SI-RNTI in response to that the user equipment is in a sleep duration and does not receive a wake-up signal (WUS) that is used for indicating wake-up.

In a fourth aspect, there is provided a communication apparatus. The communication apparatus can be provided in a network device and include a processor, a memory, and a transceiver.

The transceiver is configured to send a wake-up signal (WUS) that is used for indicating wake-up to a user equipment in response to that there is downlink information to be received by the user equipment, or that there is update of a system message or warning information is generated.

In a fifth aspect, there is provided a communication apparatus, including a processor and a memory; the memory is configured to store a computer program; the processor is configured to execute the computer program to perform the method according to the first aspect.

In a sixth aspect, there is provided a communication apparatus, including a processor and a memory; the memory is configured to store a computer program: the processor is configured to execute the computer program to perform the method according to the second aspect.

In the seventh aspect, there is provided a computer-readable storage medium having stored thereon instructions (or called a computer program or a programs) which, when being executed on a processor, cause the processor to perform the method according to the above first aspect.

In an eighth aspect, there is provided a computer-readable storage medium having stored thereon instructions (or called a computer program or a programs) which, when being executed on a processor, cause the processor to perform the method according to the above second aspect.

It is to be understood that the foregoing general description and the following detailed description are exemplary and explanatory only and cannot restrict the present disclosure.

### BRIEF DESCRIPTION OF THE DRAWINGS

The accompanying drawings, which are incorporated in and constitute a part of the specification, illustrate embodiments consistent with the embodiments of the present disclosure and together with the description serve to explain the principles of the embodiments of the present disclosure.

FIG. 1 is a schematic diagram of architecture of a wireless communication system provided by an embodiment of the present disclosure;

FIG. 2 is a flow chart showing a method for monitoring downlink control information according to an illustrative embodiment:

FIG. 3 is a flow chart showing a method for monitoring downlink control information according to an illustrative embodiment:

FIG. 4 is a flow chart showing a method for monitoring downlink control information according to an illustrative embodiment:

FIG. 5 is a flow chart showing a method for monitoring downlink control information according to an illustrative embodiment:

FIG. 6 is a flow chart showing a method for monitoring downlink control information according to an illustrative embodiment:

FIG. 7 is a flow chart showing a method for monitoring downlink control information according to an illustrative embodiment:

FIG. 8 is a structural diagram showing an apparatus for monitoring downlink control information according to an illustrative embodiment:

FIG. 9 is a structural diagram showing an apparatus for monitoring downlink control information according to an illustrative embodiment:

FIG. 10 is a structural diagram showing an apparatus for monitoring downlink control information according to an illustrative embodiment: and

FIG. 11 is a structural diagram showing an apparatus for monitoring downlink control information according to an illustrative embodiment.

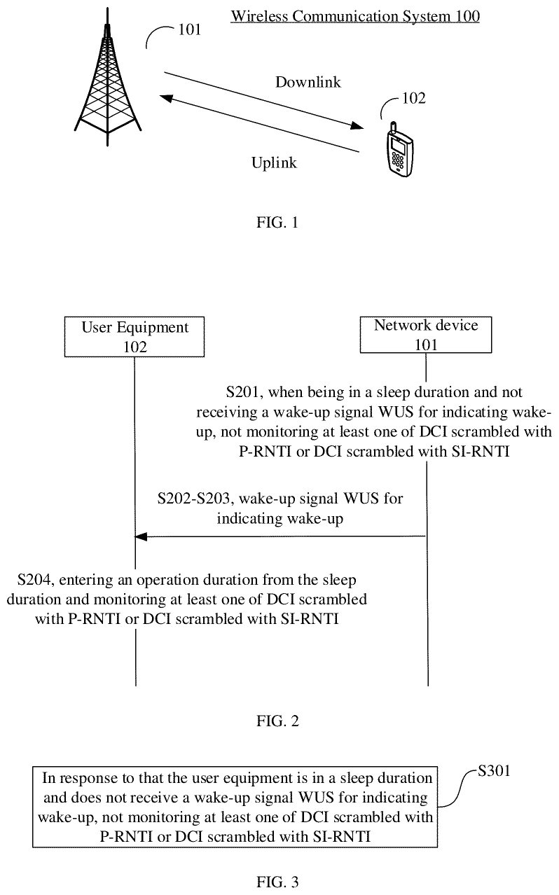

### DETAILED DESCRIPTION

In some implementations, the user equipment still needs to monitor the DCI scrambled with P-RNTI and the DCI scrambled with SI-RNTI during the sleep period.

When the user equipment uses the periodic discontinuous reception (DRX) mechanism, it periodically enters the sleep mode at certain times. When the user equipment uses DRX and enters the sleep mode, it is in an off duration. After waking up from the sleep mode, it enters an on duration.

In some implementations, the user equipment still needs to monitor the DCI scrambled with a Paging Radio Network Temporary Identifier (P-RNTI) and the DCI scrambled with a System Information RNTI (SI-RNTI) during the DRX-off period.

In the embodiments of the present disclosure, there is provided a method for monitoring downlink control information. FIG. 2 is a flow chart of monitoring downlink control information according to an illustrative embodiment. As shown in FIG. 2, the method includes the following steps.

In step S201, when a user equipment 102 is in a sleep duration and does not receive a wake-up signal (WUS) that is used for indicating wake-up, it does not monitor at least one of the following DCIs: a DCI scrambled with P-RNTI or a DCI scrambled with SI-RNTI.

In step S202, in response to that there is downlink information to be received by the user equipment 102, or that there is update of a system message or warning information is generated, the network device 101 sends the wake-up signal (WUS) that is used for indicating wake-up to the user equipment 102.

In step S203: the user equipment 102 receives the wake-up signal (WUS) that is used for indicating wake-up.

In step S204: after receiving the wake-up signal (WUS) that is used for indicating wake-up, the user equipment 102 enters an operation duration from the sleep duration, and monitors at least one of the following DCIs: the DCI scrambled with P-RNTI or the DCI scrambled with SI-RNTI.

In some implementations, the sleep duration refers to a time period during which the user equipment 102 stops monitoring a downlink channel or stops monitoring a specific downlink control channel and a downlink data channel corresponding to the downlink control channel.

In some implementations, that the user equipment 102 is in the sleep duration corresponds to that the user equipment 102 is in the DRX off duration.

In some implementations, in step S201, the user equipment 102 is in the DRX off duration, does not receive the wake-up signal WUS for indicating wake-up, and does not monitor at least one of the following DCIs: the DCI scrambled with P-RNTI or the DCI scrambled with SI-RNTI.

In some implementations, in step S204, the user equipment 102 enters the operation duration from the sleeping duration after receiving the wake-up signal WUS for indicating wake-up, which corresponds to that the user equipment 102 enters the DRX on duration from the DRX off duration after receiving the wake-up signal WUS for indicating wake-up.

In some implementations, in step S204, after receiving the wake-up signal WUS indicating wake-up, the user equipment 102 enters the operation duration from the sleep duration, and periodically monitors the DCI scrambled with P-RNTI.

In some implementations, in step S204, after receiving the wake-up signal WUS indicating wake-up, the user equipment 102 enters the operation duration from the sleep duration, and periodically monitors the DCI scrambled with P-RNTI. And in response to that the DCI scrambled with P-RNTI is sensed and the DCI scrambled with P-RNTI indicates update of a system message, the user equipment 102 monitors the DCI scrambled with SI-RNTI.

In the embodiments of the present disclosure, when the user equipment 102 is in the sleep duration and does not receive the wake-up signal WUS for indicating wake-up, it does not monitor at least one of the following DCIs: the DCI scrambled with P-RNTI and the DCI scrambled with SI-RNTI, thereby reducing the power consumption of the user equipment, and by using the reception of the wake-up signal WUS for indicating wake-up as a trigger condition for starting corresponding monitoring, it can ensure that the user equipment responds in a timely manner and ensure the monitoring capability of the user equipment.

In the embodiments of the present disclosure, there is provided a method for monitoring downlink control information, which is performed by user equipment 102. FIG. 3 is a flow chart showing a method for monitoring downlink control information according to an illustrative embodiment. As shown in FIG. 3, the method includes the following steps.

In step S301, in response to that the user equipment is in a sleep duration and does not receive a wake-up signal WUS that is used for indicating wake-up, it does not monitor at least one of the following DCIs: a DCI scrambled with P-RNTI or a DCI scrambled with SI-RNTI.

In some implementations, the sleep duration refers to a time period during which the user equipment 102 stops monitoring a downlink channel, or stops monitoring a specific downlink control channel and a downlink data channel corresponding to the downlink control channel.

In some implementations, in response to that the user equipment is in a DRX off duration and does not receive the wake-up signal WUS that is used for indicating wake-up, it does not monitor at least one of the following DCIs: the DCI scrambled with P-RNTI or the DCI scrambled with SI-RNTI.

In the embodiments of the present disclosure, when the user equipment 102 is in the sleep duration and does not receive the wake-up signal WUS indicating wake-up, it does not monitor at least one of the following DCIs: the DCI scrambled with P-RNTI or the DCI scrambled with SI-RNTI, thereby reducing the power consumption of the user equipment.

In the embodiments of the present disclosure, there is provided a method for monitoring downlink control information, which is performed by user equipment 102. FIG. 4 is a flow chart showing a method for monitoring downlink control information according to an illustrative embodiment. As shown in FIG. 4, the method includes the following steps.

In step S401, in response to entering an operation duration from a sleep duration after receiving a wake-up signal WUS that is used for indicating wake-up, it monitors at least one of the following DCIs: a DCI scrambled with P-RNTI or a DCI scrambled with SI-RNTI.

In some implementations, the sleep duration refers to a time period during which the user equipment 102 stops monitoring a downlink channel, or stops monitoring a specific downlink control channel and a downlink data channel corresponding to the downlink control channel.

In some implementations, the wake-up signal WUS that is used for indicating wake-up is sent by a network device in response to that there is downlink information to be received by the user equipment.

In some implementations, the wake-up signal WUS that is used for indicating wake-up is sent by the network device in response to that there is update of a system message or warning information is generated.

In some implementations, in response to receiving the wake-up signal WUS that is used for indicating wake-up, it enters a DRX on duration from a DRX off duration, and monitors at least one of the following DCIs: the DCI scrambled with P-RNTI or the DCI scrambled with SI-RNTI.

In the embodiments of the present disclosure, receiving the wake-up signal WUS for indicating wake-up is used as the trigger condition for starting the corresponding monitoring, which can ensure that the user equipment responds in a timely manner and ensure the monitoring capability of the user equipment.

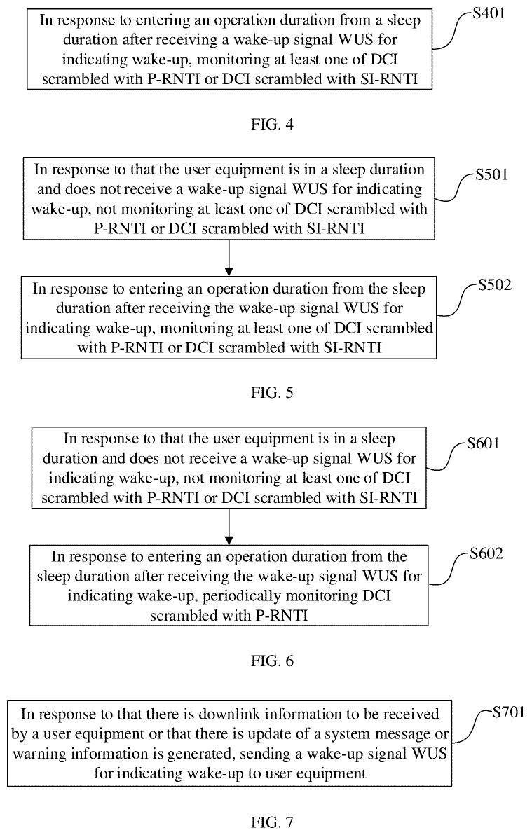

In the embodiments of the present disclosure, there is provided a method for monitoring downlink control information, which is performed by user equipment 102. FIG. 5 is a flow chart showing a method for monitoring downlink control information according to an illustrative embodiment. As shown in FIG. 5, the method includes the following steps.

In step S501, in response to that the user equipment is in a sleep duration and does not receive a wake-up signal WUS that is used for indicating wake-up, it does not monitor at least one of the following DCIs: a DCI scrambled with P-RNTI or a DCI scrambled with SI-RNTI.

In step S502, in response to entering an operation duration from the sleep duration after receiving the wake-up signal WUS that is used for indicating wake-up, it monitors at least one of the following DCIs: the DCI scrambled with P-RNTI or the DCI scrambled with SI-RNTI.

In some implementations, the sleep duration refers to a time period during which the user equipment 102 stops monitoring a downlink channel, or stops monitoring a specific downlink control channel and a downlink data channel corresponding to the downlink control channel.

In some implementations, in response to that the user equipment is in a DRX off duration and does not receives the wake-up signal WUS that is used for indicating wake-up, it does not monitor at least one of the following DCIs: the DCI scrambled with P-RNTI or the DCI scrambled with SI-RNTI.

In some implementations, in response to entering a DRX on duration from a DRX off duration after receiving the wake-up signal WUS that is used for indicating wake-up, it monitors at least one of the following DCIs: the DCI scrambled with P-RNTI or the DCI scrambled with SI-RNTI.

In some implementations, the wake-up signal WUS that is used for indicating wake-up is sent by a network device in response to that there is downlink information to be received by the user equipment.

In some implementations, the wake-up signal WUS that is used for indicating wake-up is sent by the network device in response to that there is update of a system message or warning information is generated.

In the embodiments of the present disclosure, there is provided a method for monitoring downlink control information, which is performed by user equipment 102. FIG. 6 is a flow chart showing a method for monitoring downlink control information according to an illustrative embodiment. As shown in FIG. 6, the method includes the following steps.

In step S601, in response to that the user equipment is in a sleep duration and does not receive a wake-up signal WUS that is used for indicating wake-up, it does not monitor at least one of the following DCIs: a DCI scrambled with P-RNTI or a DCI scrambled with SI-RNTI.

In step S602, in response to entering an operation duration from the sleep duration after receiving the wake-up signal WUS that is used for indicating wake-up, it periodically monitors the DCI scrambled with P-RNTI.

In some implementations, the sleep duration refers to a time period during which the user equipment 102 stops monitoring a downlink channel, or stops monitoring a specific downlink control channel and a downlink data channel corresponding to the downlink control channel.

In some implementations, in step S602, the DCI scrambled with P-RNTI is monitored once every two Paging cycles.

In some implementations, the method further includes: in response to that the DCI scrambled with P-RNTI is sensed and the DCI scrambled with P-RNTI indicates update of a system message, monitoring the DCI scrambled with SI-RNTI.

In some implementations, the wake-up signal WUS that is used for indicating wake-up is sent by a network device in response to that there is downlink information to be received by the user equipment.

In some implementations, the wake-up signal WUS that is used for indicating wake-up is sent by the network device in response to that there is update of a system message or warning information is generated.

In some implementations, in step S601, in response to that the user equipment is in a DRX off duration and does not receive the wake-up signal WUS for indicating wake-up, it does not monitor at least one of the following DCIs: the DCI scrambled with P-RNTI or the DCI scrambled with SI-RNTI.

In some implementations, in step S602, in response to entering a DRX on duration from the DRX off duration after receiving the wake-up signal WUS for indicating wake-up, it periodically monitors the DCI scrambled with P-RNTI.

In the embodiments of the present disclosure, there is provided a method for monitoring downlink control information, which is performed by a network device 101. FIG. 7 is a flow chart showing a method for monitoring downlink control information according to an illustrative embodiment. As shown in FIG. 7, the method includes the following steps.

In step S701, in response to that there is downlink information to be received by a user equipment, or that there is update of a system message or warning information is generated, a wake-up signal WUS for indicating wake-up is sent to the user equipment.

In some implementations, the wake-up signal WUS is used to assist the user equipment in determining whether to monitor at least one of the following DCIs: a DCI scrambled with P-RNTI or a DCI scrambled with SI-RNTI.

In some implementations, the wake-up signal WUS is used to assist the user equipment in determining whether to monitor at least one of the following DCIs under DRX: DCI scrambled with P-RNTI and DCI scrambled with SI-RNTI.

In the embodiments of the present disclosure, the network device 101 sends the wake-up signal WUS for indicating wake-up to the user device in response to that there is downlink information to be received by the user device or that there is update of a system message or warning information is generated, and by using the wake-up signal WUS for indicating wake-up as a trigger condition for the user device to start monitoring, it can ensure that the user device responds in a timely manner and ensure the monitoring capability of the user device.

Based on the same concept as in the above method embodiments, the embodiments of the present disclosure further provide a communication apparatus, which may have the functions of the user equipment 102 in the above method embodiments, and is configured to perform the steps performed by the user equipment 102 provided in the above embodiments. The functions may be implemented by hardware, by software, or by hardware executing corresponding software. The hardware or software includes one or more modules corresponding to the above functions.

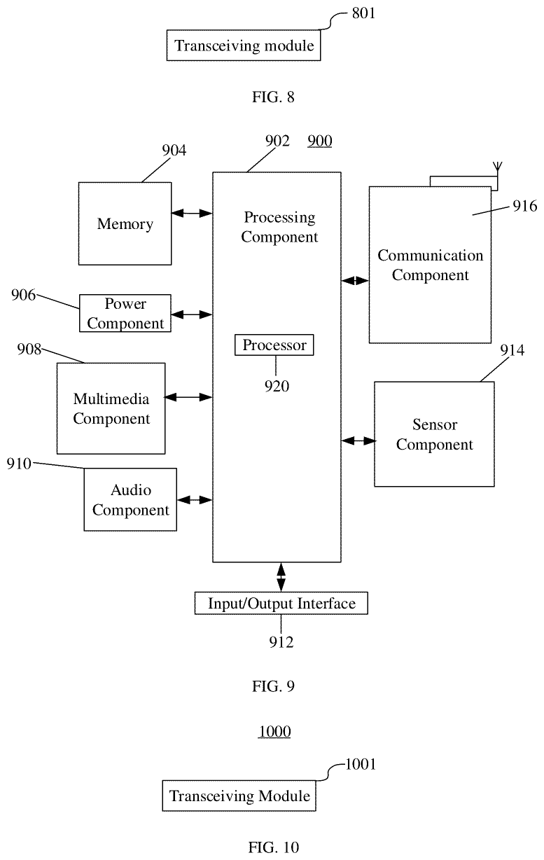

In an implementation, the communication apparatus 800 shown in FIG. 8 may serve as the user equipment 102 involved in the above method embodiments, and perform the steps executed by the user equipment 102 in the above method embodiments.

The communication apparatus 800 includes a transceiving module 801.

The transceiving module 801 is configured to not monitor at least one of the following DCIs: a DCI scrambled with P-RNTI or a DCI scrambled with SI-RNTI, in response to that the user equipment is in a sleep duration and does not receive a wake-up signal WUS that is used for indicating wake-up.

In some implementations, the transceiving module 801 is further configured to monitor at least one of the following DCIs: the DCI scrambled with P-RNTI or the DCI scrambled with SI-RNTI in response to entering an operation duration from the sleep duration after receiving the wake-up signal WUS that is used for indicating wake-up.

In some implementations, the transceiving module 801 is further configured to periodically monitor the DCI scrambled with P-RNTI in response to entering an operation duration from the sleep duration after receiving the wake-up signal WUS that is used for indicating wake-up.

In some implementations, the transceiving module 801 is further configured to monitor the DCI scrambled with SI-RNTI in response to that the DCI scrambled with P-RNTI is sensed and the DCI scrambled with P-RNTI indicates update of a system message.

In some implementations, the wake-up signal WUS that is used for indicating wake-up is sent by a network device in response to that there is downlink information to be received by the user equipment, or is sent by the network device in response to that there is update of a system message or warning information is generated.

When the communication apparatus is a user equipment, structure thereof may also be as shown in FIG. 9. FIG. 9 is a block diagram of an apparatus 900 for monitoring downlink control information according to an illustrative embodiment. For example, the apparatus 900 may be a mobile phone, a computer, a digital broadcast terminal, a message transceiving device, a game console, a tablet device, a medical device, a fitness device, a personal digital assistant, etc.

Referring to FIG. 9, the apparatus 900 may include one or more of the following components: a processing component 902, a memory 904, a power component 906, a multimedia component 908, an audio component 910, an input/output (I/O) interface 912, a sensor component 914, and a communication component 916.

The processing component 902 generally controls the overall operation of the apparatus 900, such as operations associated with display, phone calls, data communications, camera operations, and recording operations. The processing component 902 may include one or more processors 920 to execute instructions to complete all or part of the steps of the above methods. In addition, the processing component 902 may include one or more modules to facilitate the interaction between the processing component 902 and other components. For example, the processing component 902 may include a multimedia module to facilitate the interaction between the multimedia component 908 and the processing component 902.

The memory 904 is configured to store various types of data to support operations at the apparatus 900. Examples of such data include instructions for any application or method operating on the apparatus 900, contact data, phone book data, messages, pictures, videos, etc. The memory 904 can be implemented by any type of volatile or non-volatile storage device or a combination thereof, such as a static random access memory (SRAM), an electrically erasable programmable read-only memory (EEPROM), an erasable Programmable read-only memory (EPROM), a programmable read-only memory (PROM), a read-only memory (ROM), a magnetic memory, a flash memory, a magnetic disk or an optical disk.

The power component 906 provides power to the various components of the apparatus 900. The power component 906 may include a power management system, one or more power supplies, and other components associated with generating, managing, and distributing power for the apparatus 900.

The multimedia component 908 includes a screen that provides an output interface between the apparatus 900 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensor may not only sense a boundary of a touch or swipe action, but also detect duration and pressure associated with the touch or swipe operation. In some embodiments, the multimedia component 908 includes a front camera and/or a rear camera. When the apparatus 900 is in an operating mode, such as a shooting mode or a video mode, the front camera and/or the rear camera may receive external multimedia data. Each of the front camera and the rear camera may be a fixed optical lens system or have a focal length and optical zoom capability.

The audio component 910 is configured to output and/or input audio signals. For example, the audio component 910 includes a microphone (MIC), and when the apparatus 900 is in an operating mode, such as a call mode, a recording mode, and a speech recognition mode, the microphone is configured to receive an external audio signal. The received audio signal can be further stored in the memory 904 or sent via the communication component 916. In some embodiments, the audio component 910 also includes a speaker for outputting audio signals.

The I/O interface 912 provides an interface between the processing component 902 and peripheral interface modules. The peripheral interface module may be a keyboard, a click wheel, a button, and the like. These buttons may include, but are not limited to, a home button, a volume button, a start button, and a lock button.

The sensor component 914 includes one or more sensors for providing status assessments of various aspects of the apparatus 900. For example, the sensor component 914 can detect the open/closed state of the apparatus 900, the relative positioning of components, such as the display and keypad of the apparatus 900, and the sensor component 914 can also detect a change in the position of the apparatus 900 or a component of the apparatus 900, the presence or absence of user contact with the apparatus 900, the orientation or acceleration/deceleration of the apparatus 900, and temperature changes of the apparatus 900. The sensor component 914 may include a proximity sensor configured to detect the presence of a nearby object without any physical contact. The sensor component 914 may also include an optical sensor, such as a CMOS or CCD image sensor, for use in imaging applications. In some embodiments, the sensor component 914 may also include an acceleration sensor, a gyroscope sensor, a magnetic sensor, a pressure sensor, or a temperature sensor.

The communication component 916 is configured to facilitate wired or wireless communication between the apparatus 900 and other apparatuses. The apparatus 900 can access a wireless network based on a communication standard, such as Wi-Fi, 4G or 5G, or a combination thereof. In an illustrative embodiment, the communication component 916 receives a broadcast signal or broadcast-related information from an external broadcast management system via a broadcast channel. In an illustrative embodiment, the communication component 916 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an illustrative embodiment, the apparatus 900 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above methods.

In an illustrative embodiment, there is also provided a non-transitory computer-readable storage medium including instructions, such as a memory 904 including instructions, and the instructions can be executed by a processor 920 of the apparatus 900 to perform the above methods. For example, the non-transitory computer-readable storage medium can be a ROM, a random access memory (RAM), a CD-ROM, a magnetic tape, a floppy disk, an optical data storage device, etc.

Based on the same concept as in the above method embodiments, the embodiments of the present disclosure also provide a communication apparatus, which can have the functions of the network device 101 in the above method embodiments, and is configured to perform the steps performed by the network device 101 provided in the above embodiments. The functions can be implemented by hardware, by software or by hardware executing corresponding software. The hardware or software includes one or more modules corresponding to the above functions.

In an implementation, the communication apparatus 1000 as shown in FIG. 10 may serve as the network device 101 involved in the above method embodiments, and perform the steps performed by the network device 101 in the above method embodiments.

The communication apparatus 1000 includes a transceiving module 1001, configured to send a wake-up signal WUS that is used for indicating wake-up to a user equipment in response to that there is downlink information to be received by the user equipment, or that there is update of a system message or warning information is generated.

In some implementations, the wake-up signal WUS is used to assist the user equipment in determining whether to monitor at least one of the following DCIs: a DCI scrambled with P-RNTI or a DCI scrambled with SI-RNTI.

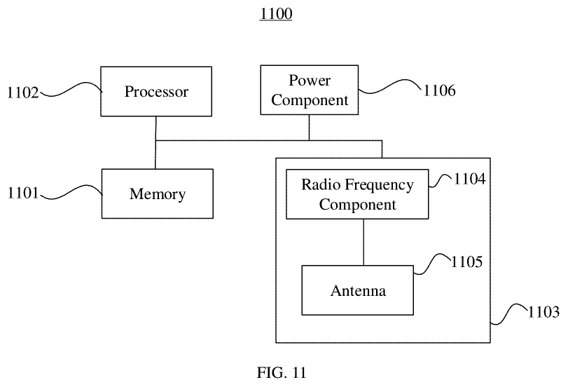

When the communication apparatus is a network device, the structure thereof may also be as shown in FIG. 11. The structure of the communication apparatus is described by taking a base station as an example of the network device 101. As shown in FIG. 11, the apparatus 1100 includes a memory 1101, a processor 1102, a transceiving component 1103, and a power component 1106. The memory 1101 is coupled with the processor 1102, and can be used to store programs and data required for the communication apparatus 1100 to implement various functions. The processor 1102 is configured to support the communication apparatus 1100 to perform the corresponding functions in the above methods, and the functions can be implemented by calling the program stored in the memory 1101. The transceiving component 1103 can be a wireless transceiver, which can be used to support the communication apparatus 1100 to receive signaling and/or data through a radio air interface, and send signaling and/or data. The transceiving component 1103 may also be referred to as a transceiving unit or a communication unit. The transceiving component 1103 may include a radio frequency component 1104 and one or more antennas 1105, the radio frequency component 1104 may be a remote radio unit (RRU), which may be specifically used for transmission of radio frequency signals and conversion between radio frequency signals and baseband signals, and the one or more antennas 1105 may be specifically used for radiation and reception of the radio frequency signals.

When the communication apparatus 1100 needs to send data, the processor 1102 can perform baseband processing on the data to be sent and output the baseband signal to the radio frequency unit. The radio frequency unit performs radio frequency processing on the baseband signal and then sends the radio frequency signal in the form of electromagnetic waves through the antenna. When data is sent to the communication apparatus 1100, the radio frequency unit receives the radio frequency signal through the antenna, converts the radio frequency signal into a baseband signal, and outputs the baseband signal to the processor 1102. The processor 1102 converts the baseband signal into data and processes the data.

Those skilled in the art will readily appreciate other implementations of the embodiments of the present disclosure after considering the specification and practicing the disclosure disclosed herein. The present disclosure is intended to cover any variations, uses, or adaptations of the embodiments of the present disclosure, which follow the general principles of the embodiments of the present disclosure and include common knowledge or conventional technical measures in the art that are not disclosed in the present disclosure. The specification and embodiments are to be considered merely illustrative, and the true scope and spirit of the embodiments of the present disclosure are specified by the following claims.

It should be understood that the embodiments of the present disclosure are not limited to the precise structures described above and shown in the drawings, and various modifications and changes may be made without departing from the scope thereof. The scope of the embodiments of the present disclosure is defined only by the appended claims.

### INDUSTRIAL APPLICABILITY

When the user equipment is in the sleep duration and does not receive the wake-up signal WUS for indicating wake-up, it does not monitor at least one of the following DCIs: a DCI scrambled with P-RNTI or a DCI scrambled with SI-RNTI, thereby reducing the power consumption of the user equipment, and by using the reception of the wake-up signal WUS for indicating wake-up as a trigger condition for starting corresponding monitoring, it can ensure that the user equipment responds in a timely manner and ensure the monitoring capability of the user equipment.

1. A method for monitoring downlink control information (DCI), the method being performed by a user equipment and comprising:
in response to that the user equipment is in a sleep duration and does not receive a wake-up signal (WUS) that is used for indicating wake-up, not monitoring at least one of a DCI scrambled with Paging Radio Network Temporary Identifier (P-RNTI) or a DCI scrambled with System Information RNTI (SI-RNTI).

2. The method according to claim 1, further comprising:
in response to entering an operation duration from the sleep duration after receiving the wake-up signal (WUS) that is used for indicating wake-up, monitoring at least one of the DCI scrambled with P-RNTI or the DCI scrambled with SI-RNTI.

3. The method according to claim 1, wherein:
in response to entering an operation duration from the sleep duration after receiving the wake-up signal (WUS) that is used for indicating wake-up, periodically monitoring the DCI scrambled with P-RNTI.

4. The method according to claim 3, further comprising:
in response to that the DCI scrambled with P-RNTI is sensed and the DCI scrambled with P-RNTI indicates update of a system message, monitoring the DCI scrambled with SI-RNTI.

5. The method according to claim 2, wherein:
the wake-up signal (WUS) that is used for indicating wake-up is sent by a network device in response to that there is downlink information to be received by the user equipment, or is sent by the network device in response to that there is update of a system message or warning information is generated.

6. A method for monitoring downlink control information (DCI), the method being performed by a network device and comprising:
in response to that there is downlink information to be received by a user equipment, or that there is update of a system message or warning information is generated, sending a wake-up signal (WUS) that is used for indicating wake-up to the user equipment.

7. The method according to claim 6, wherein:
the wake-up signal (WUS) is used to assist the user equipment in determining whether to monitor at least one of a DCI scrambled with Paging Radio Network Temporary Identifier (P-RNTI) or a DCI scrambled with System Information RNTI (SI-RNTI).

8. A communication apparatus, provided in a user equipment, the communication apparatus comprising:
a processor;
a memory; and
a transceiver configured to not monitor at least one of downlink control information (DCI) scrambled with Paging Radio Network Temporary Identifier (P-RNTI) or a DCI scrambled with System Information RNTI (SI-RNTI), in response to that the user equipment is in a sleep duration and does not receive a wake-up signal (WUS) that is used for indicating wake-up.

9. The communication apparatus according to claim 8, wherein:
the transceiver is further configured to monitor at least one of the DCI scrambled with P-RNTI or the DCI scrambled with SI-RNTI in response to entering an operation duration from the sleep duration after receiving the wake-up signal (WUS) that is used for indicating wake-up.

10. The communication apparatus according to claim 8, wherein:
the transceiver is further configured to periodically monitor the DCI scrambled with P-RNTI in response to entering an operation duration from the sleeping period after receiving the wake-up signal (WUS) that is used for indicating wake-up.

11. The communication apparatus according to claim 10, wherein:
the transceiver is further configured to monitor the DCI scrambled with SI-RNTI in response to that the DCI scrambled with P-RNTI is sensed and the DCI scrambled with P-RNTI indicates update of a system message.

12. The communication device according to claim 9, wherein:
the wake-up signal (WUS) that is used for indicating wake-up is sent by a network device in response to that there is downlink information to be received by the user equipment, or is sent by the network device in response to that there is update of a system message or warning information is generated.

13.-15. (canceled)

16. A communication apparatus, comprising:
a processor; and
a memory storing a computer program;
wherein the processor is configured to execute the computer program to implement the method according to claim 6.

17. (canceled)

18. (canceled)
